(19) United States
(12) Patent Application Publication
(10) Pub. No.: US 2015/0235270 A1
(43) Pub. Date: Aug. 20, 2015

(54) UPGRADE NOTIFICATIONS AND PROMOTIONS FOR ELECTRONIC DEVICES

(71) Applicant: Frank Partida, Farmington, MN (US)

(72) Inventor: Frank Partida, Farmington, MN (US)

(73) Assignee: BBY SOLUTIONS, INC., Richfield, MN (US)

(21) Appl. No.: 14/182,666

(22) Filed: Feb. 18, 2014

(51) Int. Cl. G06Q 30/02

(52) U.S. Cl. CPC G06Q 30/0267

(57) ABSTRACT

Methods and implementations of providing device upgrade notifications and determining device upgrade eligibility and device trade-in values are described herein. These techniques include operations to determine and obtain an upgrade status of a device (and a device's contract status with a service provider), determine and obtain characteristics of the device, determine and obtain a promotional offer for an upgrade of the device, and generate and display a promotional offer that may be output on the device itself. The upgrade status may be displayed in connection with software app or widget that outputs a countdown timer for the device upgrade and value assessment for a trade-in of the user's existing device. Other techniques for providing customized and targeted advertising and promotions for device upgrade and purchases also may be provided through use of the software app or widget.

### TECHNICAL FIELD

Embodiments pertain to electronic device operations and electronic device software applications. Some embodiments relate to electronic device software applications and implemented processes that enable capability identification and upgrade notifications for computing devices.

### BACKGROUND

Many personal electronic devices such as smartphones, watches, media players, tablets, and the like often have limited life spans for consumers and businesses and are subject to rapid upgrade cycles. For example, the manufacturer of a personal electronic device may introduce improved software or hardware that leads to a desired replacement of the electronic device within 12, 24, or 36 months. Many device users, however, may have received their device under a contractual obligation with a wireless phone carrier or other service provider. Thus, many device users may not be able to upgrade their particular device until it is time to renew their contract with the service provider (or sign a new contract with a different service provider).

In many cases, reduced and promotional pricing for a new or upgraded device is only available after a certain date, such as within four months of contract renewal for wireless phones. The contract date with the service provider often serves as an important trigger for the consumer decision on whether to upgrade the device under contract or trade in the existing device to obtain credit towards the purchase of the new device. Many consumers are not aware of the precise date of when their contract expires, and may not know whether promotional offers for new devices or device trade-in will apply to their particular situation. In particular, consumers may not be aware of whether a contract enables them to trade in their current device for an upgraded device, or what value would be assigned to their existing device in a trade-in transaction.

### BRIEF DESCRIPTION OF THE DRAWINGS

FIG. 1 illustrates an example sequence of operation of a software application providing a device upgrade notification according to an example described herein.

FIGS. 2A and 2B illustrate user interface outputs of a software application for upgrade notification according to an example described herein.

FIGS. 3A and 3B illustrate user interface outputs of a widget software application for upgrade notification according to an example described herein.

FIG. 4A illustrates an interactive method for determining promotional offers for device upgrades, according to an example described herein.

FIG. 4B illustrates an interactive method for determining device characteristics used in a device upgrade evaluation, according to an example described herein.

FIG. 5 illustrates a block diagram of computing device system components adapted for determining and providing an upgrade notification, according to an example described herein.

FIG. 6 is a block diagram illustrating operational components of a computing device upon which any one or more of the methodologies herein discussed may be run.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some of the embodiments discussed herein describe user interface components and enhancements to provide notifications of electronic device upgrades. In some examples, a notification of an electronic device upgrade is used to display the eligibility of a particular user to upgrade his or her electronic device according to a combination of factors. These factors may include: a service provider contract renewal date, a current or future promotion offered by a retailer (or service provider), a trade-in value for the existing device offered by a retailer (or service provider), a trade-in value adjustment for the existing device based on diagnostics performed on the existing device, the retail or promotional price of a new device, or similar factors (or combinations of such factors). The end user, whether a customer, business, or other purchasing entity, may be provided with a customized and targeted notification of device upgrade to encourage the device upgrade transaction from these factors.

In the examples described herein, various notifications may be provided for the upgrade eligibility of a particular electronic device such as a smartphone. These notifications may be custom suited to a new device purchase or a device trade-in scenario for the smartphone. For example, a trade-in value of a smartphone may be determined and displayed to the customer in connection with a time-limited promotional campaign and the availability of promotional pricing offered by the customer's wireless phone carrier. Diagnostics on the smartphone may provide a precise identification of the existing smartphone model and hardware version for an accurate and up-to-date trade-in value and upgrade determination. In addition, diagnostics run on the smartphone may be used to identify the condition and operating status of the smartphone and the subsystems of the smartphone (such as a display, processing, memory, battery, or other hardware subsystem) which affect the trade-in value.

Such upgrade notifications may be provided in connection with a software application operating on the electronic device, in accordance with the device operating system and device capabilities. For example, a software app may be executed directly on an existing smartphone that outputs a countdown clock/counter to display the precise date of eligibility or the amount of time remaining to receive upgrade promotional pricing. As another example, a software widget may be deployed in a “live tile”, a primary screen, or home screen of the existing smartphone, to display the countdown clock next to other widgets and prominent user interface elements of the smartphone.

The upgrade notification for the electronic device may be provided and advertised from an electronic device retailer or service provider through a combination of installed software applications and messaging. For example, targeted Short Message Service (SMS) messages may be sent to the device based on information that a particular user at the phone number may be eligible for an upgrade in the near future. (The customer's SMS phone number may be collected as a result of an online or in-person encounter, for example, which provides the retailer or service provider with permission to contact the user regarding promotions and upgrades). Other similar messaging and notification mechanisms may be used to display promotions and output relevant marketing and advertising content to users.

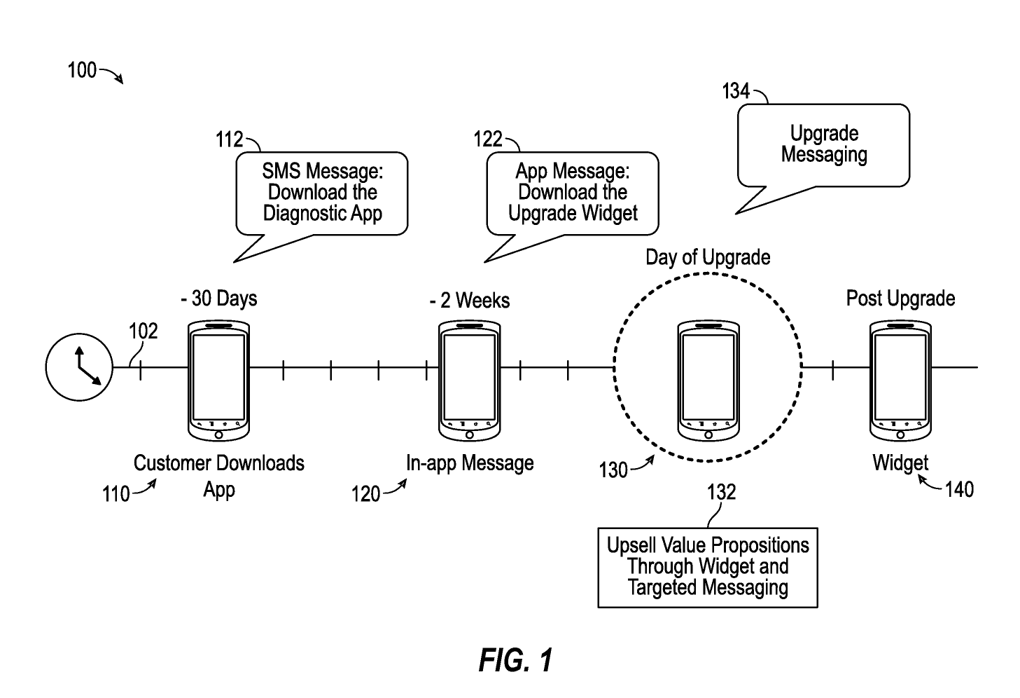

FIG. 1 provides an illustration of an example sequence of operation 100 for software applications, configured for generating and displaying a device upgrade notification according to an example described herein. As shown in FIG. 1, the operations occur during a period of time illustrated by a timeline 102. The timeline 102 illustrates points in time prior to, at, and after the upgrade of an electronic device. It will be understood, however, that the following times are offered as an example, and additional marketing and promotional activities may occur at other points in or outside the timeline.

At point in time 110, for example 30 days before the device upgrade, a customer is provided with information to download a software application. The information to download or promote the software application may be provided through an SMS message 112 or notification (e.g., push or e-mail notification) that provides a hyperlink for a user to download and launch the software application (e.g., in the form of a link to a website or app store, such as an app store that is specific to the operating system of the computing device or a service provider providing a telecommunications service, content service, or like subscription service to the computing device). This downloadable software application may include a diagnostic component and may also provide functionality to trigger the upgrade notifications or trigger other actions related to the upgrade notifications. The software application, upon installation, may provide a mechanism for obtaining and outputting promotional content relevant to the device upgrade.

The software application, for example, may be a smartphone app provided by a consumer electronics retailer that provides shopping functions. As another example, the software application may be a smartphone app which has device utility and diagnostic functions. As yet another example, the software application may be a news, entertainment, sports, or other shopping app, which provides the upgrade notification component as a secondary feature to other news, entertainment, sports, or shopping features. A variety of software providers may provide distribution channels for the software application.

At point in time 120, for example 2 weeks before the upgrade, an in-application message is provided on the electronic device. This may be a notification, alert, or other type of in-app message 122 or advertisement that encourages the user to download and install an upgrade widget. This widget may serve as a prominent or intrusive user interface mechanism to inform the user about the status of the upgrade and allow the user to interact with other features of an upgrade application. The widget may be installed and deployed through a variety of user interface interactions, including interactions in the software app downloaded at time 110.

At point in time 130, some combination of value propositions, advertisements, custom offers, and promotions 132 are offered and output to the user. These offers may be accompanied by upgrade messaging 134 (e.g., SMS messages) which informs the customer of time-limited promotions and directs the user to view current offers on the upgrade widget. Such promotions 132 and messaging 134 may be used to “upsell” the customer to upgrade their existing device to a more profitable electronic device or purchase package. For example, the widget may be used to offer certain time-limited offers relevant to a device upgrade, which may be redeemed by a user when accompanied by a trade-in of the user's existing device. Then, at point in time 130, the user chooses to upgrade the device and redeem one of the targeted offers.

At point in time 140, after the device upgrade, the widget may be placed in a prominent or intrusive placement on the upgraded electronic device to allow further use and targeted offers. For example, the upgraded electronic device may be pre-installed with the widget, or may be installed based on the user profile transferred over from the previous electronic device (e.g., from a list of installed Android or iOS apps or widgets associated with the user's profile). The widget may provide additional relevant content after upgrade, such as help, support tips, diagnostic functions, and the like relevant to the new device. The widget may also be used to provide other advertising functions for the retailer or service provider where the device was obtained.

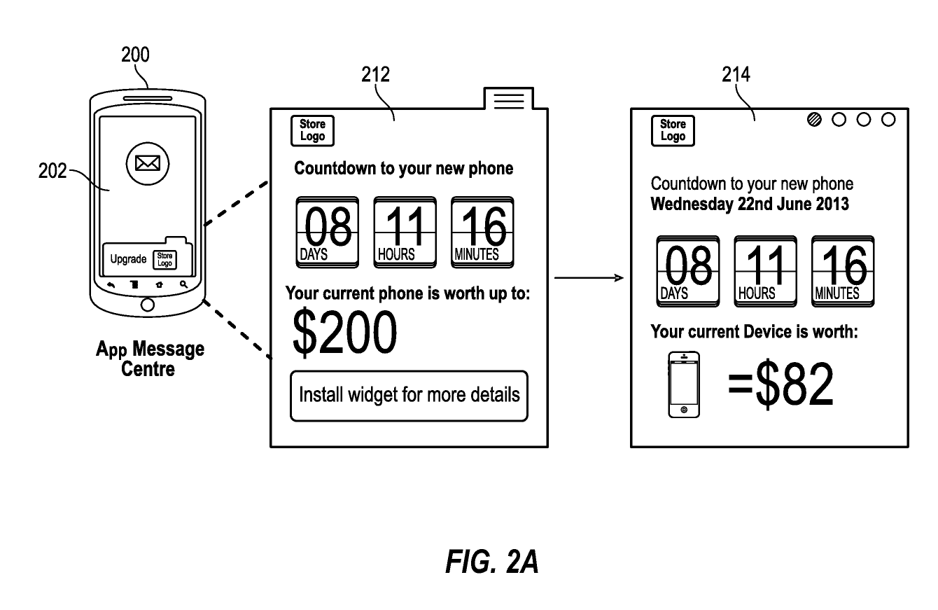

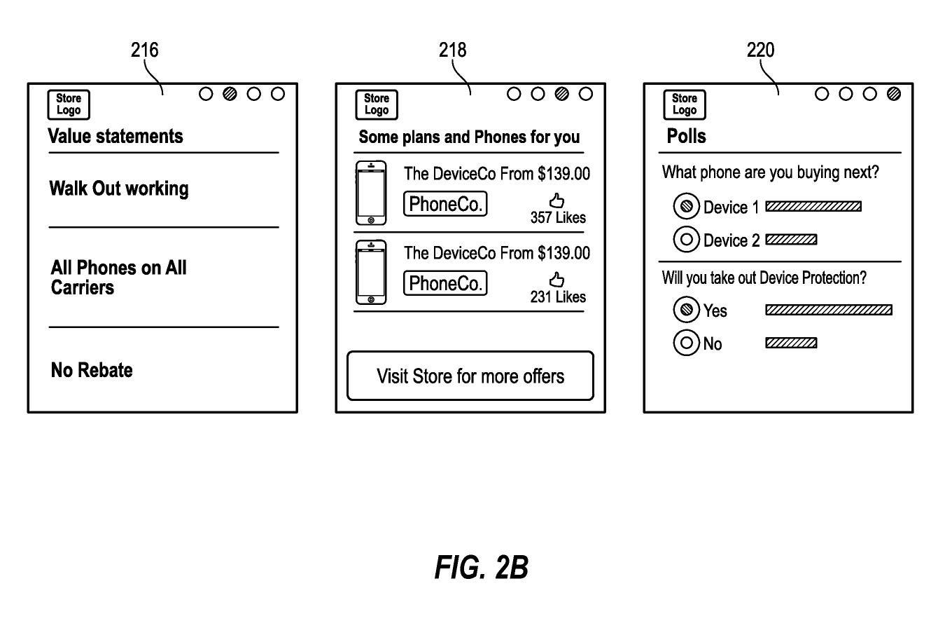

FIGS. 2A and 2B illustrate example user interface outputs of a software application for device upgrade notification according to an example described herein. As shown, with operation of software application 202 on mobile device 200, various user interface displays 212, 214, 216, 218, 220 may be provided. The interfaces of FIGS. 2A and 2B are customized to the upgrade and trade-in propositions offered for a new phone, but it will be understood that similar techniques may be applied to other purchase activities and types of electronic devices (such as tablets, computers, display screens, game consoles, and the like).

User interface display 212 depicted in FIG. 2A provides an illustration of a message (e.g., the in-app message 122) that provides an indication of a countdown clock and an initial valuation of the device. This countdown clock may indicate the number of months, days, hours, minutes, seconds, and so forth, until the determined upgrade eligibility period is scheduled to begin (or change). In the user interface display 212, the initial valuation of the device (e.g., “up to $200”) that is not customized to the particular user device may be displayed. The user may be provided with an action option to obtain additional details and a more precise valuation of the device. For example, the user may need to initiate installation or activation of a widget or other software component to obtain full details on the promotion (such as by selecting a button to install the widget).

User interface displays 214, 216, 218, and 220 depicted in FIGS. 2A and 2B provide an illustration of an in-app user interface. These displays may offer the full functionality of the software or advertising promotions after the widget or other functionality of the software app 202 is installed or activated. For example, user interface 214 indicates the first screen of a series of screens in the software app 202 after the widget is installed. User interface 214 further illustrates a detailed countdown clock and a precise value of the electronic device, here $82, tailored to the precise condition of the electronic device (as determined by user indications and diagnostics performed on the device). For example, the user may answer various questions about the condition of the device, and various diagnostic tests may run to determine the condition of hardware subsystems such as the screen, speakers, microphone, processor, memory, and the like. The ability to redeem the customized offer may be conditioned on the timing of the upgrade eligibility period, verification of the device operation, a change or renewal to the contractual obligation with the service provider, retailer terms and conditions, or other factors.

As further examples, user interface 216, a second screen of the series of screens in the software app 202, provides a more detailed illustration of promotional offers, marketing materials, and other advertisements that may be provided to the user. These advertisements may be tied to a wide-scale advertising campaign or specific to the particular user profile or preferences. The user interface 218, a third screen of the series of screens in the software app 202, provides another detailed illustration of a listing of available device upgrades, and may provide a comparison of different upgraded devices (including prices, reviews and ratings) and links to commerce sites to view more offers or purchase a particular device. The user interface 220, a third screen of the series of screens in the software app 202, provides another detailed illustration of user interactive features, such as surveys and questionnaires, which may be used to customize the particular upgrade offer or advertising campaign (or collect user feedback on particular offers or promotions).

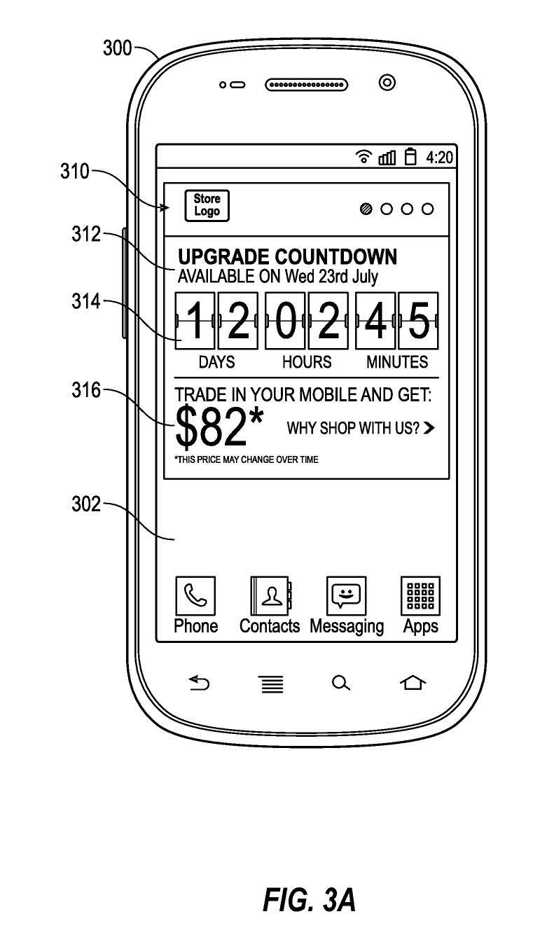

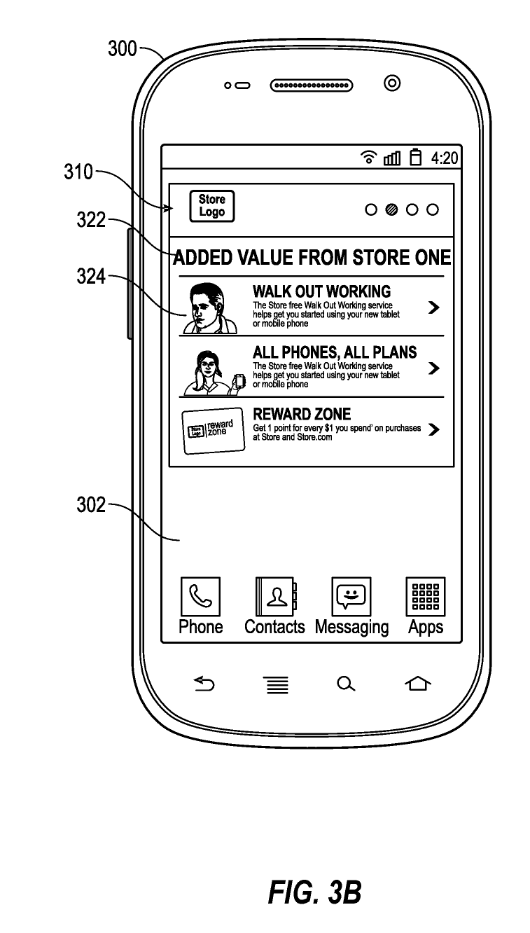

FIGS. 3A and 3B illustrate example user interface output of a software application widget 310 deployed on a smartphone 300 for upgrade notification of the smartphone 300. This widget may generate a display for the device's “home screen” such as the primary screen generated for an Android or iOS smartphone (which in some examples may be launched in response to interaction with a notification in a notifications screen). As shown, the widget 310 is configured to operate on the home screen 302 of the smartphone 300, and may be accompanied by other widgets and interactive UI elements. The widget 310 may include all or some of the content of the software application that provides the user interface displays 212, 214, 216, 218, 220.

For example, FIG. 3A depicts an illustration of a first screen of the widget software application 310 configured to display a particular upgrade advertising message 312, along with a countdown clock 314. This may be accompanied by a customized message or selectable option 316 to launch a webpage, message, or information display about a particular device upgrade promotion. Interaction with the other components of the widget 310 may also perform an action such as launching a software app (e.g., the software app 202), launching a webpage, initiating a call or message, and the like.

As a further example, FIG. 3B depicts an illustration of a second screen of the widget 310 configured to display a further promotional message 322 and other actionable or selectable items 324. The promotional message 322 and other actionable or selectable items 324 may facilitate the device upgrade or other purchases from the merchant or service provider. The promotional message 322 and the other actionable or selectable items 324 may be customized based on the particular profile of the user, tracked shopping activities, the device type, the service provider (e.g., wireless carrier), and the like.

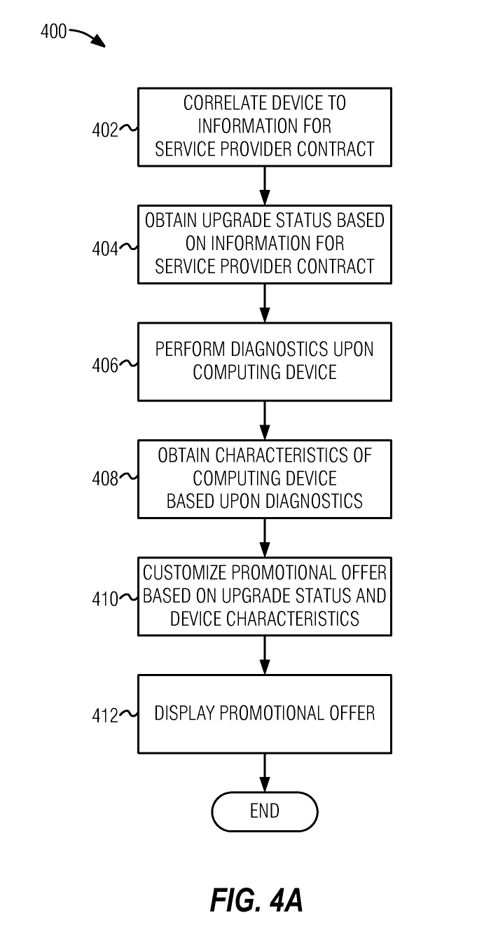

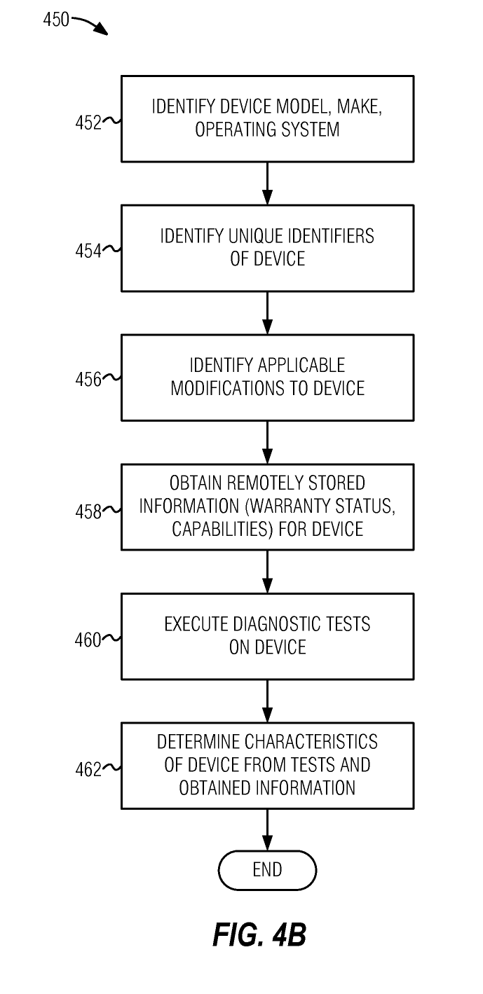

FIG. 4A illustrates an interactive method 400 for determining promotional offers for an upgrade of a computing device, according to an example described herein. The method 400 may be implemented in connection with one or more software applications operating on the computing device, and in connection with communications to remote data services and entities. For example, the method 400 may obtain information with the use of software applications and components installed directly on the computing device.

The method 400 is illustrated as including a series of steps used to obtain information relevant to the device and the relevant service provider contractual obligation, and display information based on at least these two sources of information. For example, information on the device (such as phone number, device identifier, user identifier, and the like) may be correlated to information maintained at a remote data service for a specific service provider contractual obligation (operation 402). This information may be retrieved, downloaded, or accessed from a remote data service to determine when a particular upgrade eligibility or contract expiration date will occur, for example. From this information, the upgrade status of the computing device can be obtained (operation 404).

Various diagnostic actions may be performed upon the computing device (operation 406) to verify the condition of the device. These actions may produce diagnostic information and other collectable information to produce a list of characteristics for the computing device, including device capabilities, device operating status, detected damage and inoperable systems, and the like. Similar information related to the status and characteristics of the device may be retrieved from external data sources. From the information obtained during actions in the diagnostic process, the characteristics of the computing device can be obtained and produced (operation 410).

The promotional offer to encourage a device upgrade may be selected or customized to the user and the user's device, based on the upgrade status (obtained in operation 410) and the device characteristics (obtained in operation 408). In some examples, the promotional offer may be obtained by communicating the operating characteristics of the computing device and the upgrade status of the computing device to a remote service (e.g., a retailer advertising or marketing service) that provides a customized promotional offer. This promotional offer may then be displayed to the user (operation 412) in the software application, through messaging, notifications, or advertisements, access by the user on-demand, or otherwise output or generated for display.

FIG. 4B illustrates an interactive method 450 for determining device characteristics used in an upgrade evaluation of a computing device, according to an example described herein. The operations of method 450 may be performed in connection with operation 408 of method 400, or may be performed separately. For example, the operations of method 450 may be performed by a software application (including a third party software application) which is configured to run diagnostics and communicate with a remote server. In addition, some of the characteristics information obtained with method 450 may be determined from information stored by remote services and software applications.

The method 450 includes a series of operations to determine the particular characteristics of the device, such as identifying the device model, make, operating system, and other installed software (operation 452), and identifying one or more unique identifiers of the device (operation 454). This identifying can be used to identify a particular device model and configuration, such as a particular smartphone model. In addition, diagnostic tests may be performed to identify applicable modifications to the device (operation 456) such as whether the device is unlocked, rooted, or has been modified by the user. Remotely stored information related to the device, such as warranty status, device capabilities, and conditions for the device, may be obtained from remote data services (operation 458).

Based on the identified information for the device, various diagnostic tests may be executed on the device (operation 460). These tests may include automated and user-interactive diagnostic tests to verify the status of the processor, memory, display, touch screen, microphone, speakers, and other electronic components and subsystems. The remotely stored information from operation 458 may be used to customize the diagnostic tests that are executed on the mobile device. The results of the diagnostic tests and the various information obtained related to the device (such as operating parameters, identifiers, modifications, and remote information) may be used to produce a determination of the characteristics of the device (operation 462) and the operating conditions of one or more device subsystems.

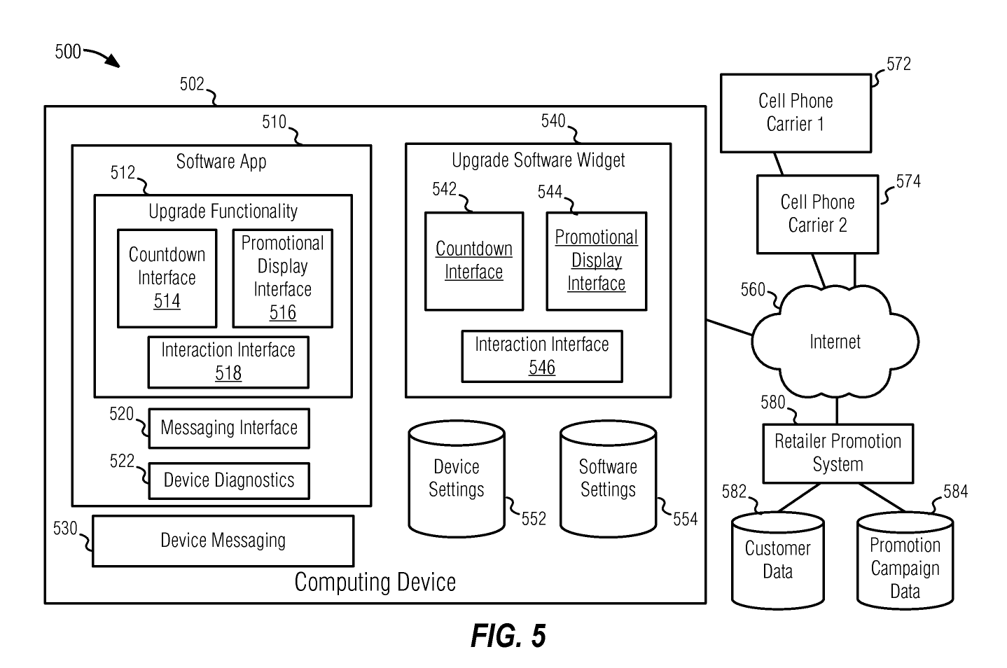

FIG. 5 illustrates a block diagram 500 of computing device system components adapted for determining and providing an upgrade notification, with use of a software app 510 and the software widget 540 operating on the computing device 502. The computing device 502 includes a processor, memory, operating system, and user input interface (not directly shown) to provide interaction with the software app 510 and software widget 540. For example, the computing device 502 may include a touchscreen that is used to receive user commands and interact with execution instances of the software app 510 and software widget 540. The computing device 502 may also include communication functionality for connection to the internet 560 to download and upload data in connection with instances of the software app 510 and the software widget 540.

The software app 510 is illustrated as including an upgrade functionality component 512 in addition to a messaging interface component 520 and device diagnostics component 522. In some examples, the software app 510 may provide other features outside of the upgrade functionality component 512 (in the form of news, sports, entertainment, games, shopping, or multimedia features), and the upgrade functionality component 512 may be bundled as a one or many operating components for the software app 510. In other examples, the software app 510 may operate as a standalone app which provides exclusive functionality related to device upgrades or related device utility features.

The upgrade functionality component 512 included in the software app 510 may include: a countdown interface 514 configured to determine and display a countdown calendar, clock, or other display of time until an eligible upgrade date (or when the upgrade status of the device is otherwise scheduled to change); a promotional display interface 516 configured to determine and display eligible promotional information related to a device upgrade; and an interaction interface 518 configured to receive and display information from the user related to promotions, upgrades, demographic information and preference information, and the like. The upgrade functionality component 512 may interact with a messaging interface component 520 of the software app 510 to provide messages, notifications, and information displays to the device via device messaging component 530; and a device diagnostics component 522 configured to test and determine the status of the device (e.g., operating characteristics, and a status of one or more device subsystems) that may be used in connection with determining a trade-in value of the device. The functionality of messaging interface component 520 and device diagnostics component 522 may be provided by calls to other software applications or operating system features (e.g., application programming interfaces (APIs) or third party software).

Further, the device diagnostics component 522 may be used for a variety of data collection and testing features, for use in a device upgrade evaluation. These diagnostic features may be provided from operation of the software app 510 by itself, by a third party app, or from built-in operating system operations or other sources. For example, applicable diagnostic feedback from the device may include the make and model number of the device, a serial number of the device, what OS version is running, whether the device is “rooted,” and whether the device is under a service plan. The diagnostic functions also may be used for other purposes (e.g., to assist customers in troubleshooting issues and to identify potential problems).

The diagnostic information processed by the device diagnostics component 522 may be stored internally in the device within the software app 510 or with a device settings data store 552. With this diagnostic information, a retailer, service provider, or third party may correlate specific characteristics of the device to promotional offers and trade-in values. In further examples, the device diagnostics component 522 may be used during a remotely-evaluated trade in. For example, various technical tests may be executed by the device diagnostics component 522 to test which features of the device operate successfully; and if the device has a sufficient number of features that operate successfully, to approve the device for a trade in. Diagnostic information may be communicated to a remote server to tie results of a particular diagnostic test to a specific identifiable device (e.g., identified by International Mobile Station Equipment Identity (IMEI) number).

The upgrade software widget 540 may include similar features in use of a countdown interface 542, a promotional display interface 544, and an interaction interface 546 (operating similarly to the countdown interface 514, the promotional display interface 516, and the interaction interface 518 respectively). The upgrade software widget 540 and the software app 510 may each access a local software settings data store 554 used to store user preferences for use of the application (such as preferences related to notifications, messages, and the like). Accordingly, information used in obtaining the upgrade status of the device may be obtained at least in part from device information in the device settings data store 552, and information used in obtaining the operating characteristics of the device may be obtained at least in part from software information in the software settings data store 554.

The offers that are provided in the promotional display interfaces 516, 544 may be tailored to the carrier (e.g., Verizon, AT&T, T-Mobile), phone platform (e.g., iOS, Android, Blackberry), and the like. For example, information communicated to the computing device 502 from the retailer promotion system 580 via the internet 560 may obtain specific offers relative to a first cell phone carrier 572 (and potentially a second cell phone carrier 574). The information communicated from the retailer promotion system 580 for use in the promotional display interfaces 516, 544 may also be customized based on specific customer data 582 and promotion campaign data 584. Other internet-connected sources of information for the promotional display interfaces 516, 544 and countdown interfaces 514, 542 may also be utilized.

While many of the examples described herein refer to portable computing devices such as smartphones, it will be understood that the techniques described herein may be deployed in a variety of internet-based or installed software interfaces on devices including communication terminals, media players, watches, smart glasses, other wearable devices, set top boxes, network terminals, and other types of various human-machine interfaces. The types of computing devices which may implement the software interfaces may include a variety of desktop, portable, or mobile computing device form factors.

Embodiments used to facilitate and perform the techniques described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

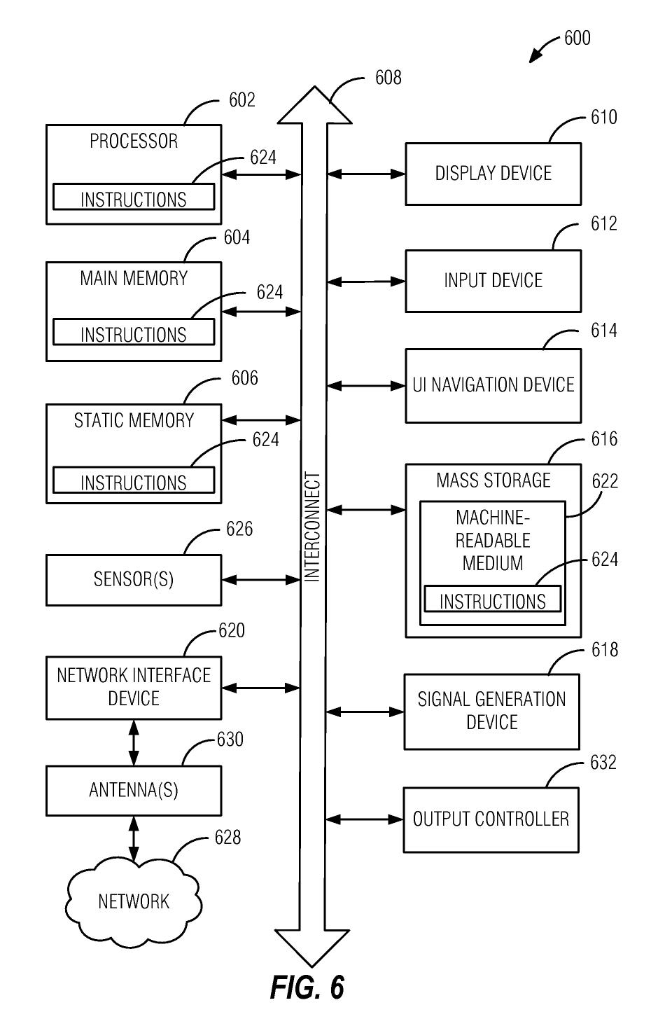

FIG. 6 is a block diagram illustrating a machine in the example form of a computer system 600, within which a set or sequence of instructions may be executed to cause the machine to perform any one of the methodologies discussed herein, according to an example embodiment. Computer system machine 600 may be embodied by the system or devices generating or outputting the interactions along timeline 102, devices 200, 300, and 502, the software application 202 and graphical user interface displays 212, 214, 216, 218, 220, 202, 310, the operating system of smartphone 300, the software application 510 and software widget 540, the system performing the operations of flowchart methods 400 and 450, or any other electronic processing or computing platform described or referred to herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via an interconnect 608 (e.g., a link, a bus, etc.). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touchscreen interface and touchscreen display. The computer system 600 may additionally include a storage device 616 (e.g., a drive unit), a signal generation device 618 (e.g., a speaker), an output controller 632, a network interface device 620 (which may include or operably communicate with one or more antennas 630, transceivers, or other wireless communications hardware), and one or more sensors 626, such as a global positioning system (GPS) sensor, compass, accelerometer, location sensor, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be communicated (e.g., transmitted or received) over a communications network 628 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the configurations recited by the claims. Each of the examples in the claims may stand on its own, or may be combined in any permutation or combination with any one or more of the other examples provided below or throughout the present disclosure.

What is claimed is:

1. A method, performed by a computing device having a processor and a memory, the method implemented by operations performed using the processor and the memory, with the operations comprising:
obtaining an upgrade status of the computing device, the upgrade status determined from a contractual obligation with a service provider;
obtaining an operating characteristic of the computing device;
obtaining a promotional offer for an upgrade of the computing device, the promotional offer customized to the operating characteristic of the computing device and the upgrade status of the computing device; and
displaying the promotional offer on the computing device.

2. The method of claim 1, further comprising displaying a countdown on the computing device, the countdown indicating a future time that the upgrade status of the computing device is scheduled to change.

3. The method of claim 1,
wherein obtaining an operating characteristic of the computing device includes performing diagnostics to determine an operating condition of a subsystem of the computing device; and
wherein displaying the promotional offer on the computing device includes displaying a trade-in value for the upgrade of the computing device, the trade-in value based at least in part on the operating condition of the subsystem of the computing device.

4. The method of claim 1, wherein obtaining a promotional offer for the upgrade of the computing device includes correlating the promotional offer to a promotional upgrade price, wherein the promotional upgrade price is based on the contractual obligation with a phone carrier, and wherein the computing device is a smartphone.

5. The method of claim 1, wherein obtaining a promotional offer for the upgrade of the computing device includes:
communicating information for the operating characteristic of the computing device and the upgrade status of the computing device to a remote service; and
receiving a customized offer from the remote service, the customized offer being customized to the information for the operating characteristic of the computing device and the upgrade status of the computing device.

6. The method of claim 1,
wherein obtaining a upgrade status of the computing device includes contacting a remote service to retrieve a status of the contractual obligation with the service provider; and
wherein the upgrade status of the computing device is correlated to a period of promotional pricing available through the service provider, the period of promotional pricing being conditioned upon a change or renewal to the contractual obligation with the service provider.

7. The method of claim 1, wherein the operations are performed by a software application installed on the computing device.

8. The method of claim 7, wherein displaying the promotional offer on the computing device is performed by a software widget presented on a home screen of the computing device.

9. A non-transitory device-readable medium including instructions for facilitating operations of an upgrade notification user interface, the instructions which when executed by a device cause the device to perform operations including:
retrieving information related to an upgrade status of the device, the upgrade status based on a contractual obligation with a service provider that provides a communications service to the device;
retrieving information related to characteristics of the device, the characteristics of the device including an operating condition of a subsystem of the device; and
generating output of a promotional offer for an upgrade of the device, the output of the promotional offer presented in a upgrade notification user interface of the device, and the promotional offer being customized to the device with use of the information related to the upgrade status of the device and the information related to characteristics of the device.

10. The device-readable medium of claim 9, wherein generating output of the promotional offer for the upgrade of the device includes generating output of a countdown display, the countdown display indicating an amount of time until the upgrade status of the device is scheduled to change, and the output of the countdown display being generated for presentation in the upgrade notification user interface of the device.

11. The device-readable medium of claim 9,
wherein retrieving information related to characteristics of the device includes retrieving diagnostic information for the device that indicates the operating condition of the subsystem of the device; and
wherein generating output of a promotional offer for the upgrade of the device includes generating output of a trade-in value display for the upgrade of the device with a retailer, the trade-in value display including a value that is based at least in part on the operating condition of the subsystem of the device, and the trade-in value display being generated for presentation in the upgrade notification user interface of the device.

12. The device-readable medium of claim 11, wherein the upgrade notification user interface of the device is presented with a screen of a user interface for a software application associated with the retailer.

13. The device-readable medium of claim 9,
wherein the device is a smartphone, wherein the service provider is a phone carrier, and wherein the instructions for facilitating operations of the upgrade notification user interface are embodied by a software application installed on the smartphone; and
wherein the promotional offer is correlated to a promotional upgrade price based at least in part on the contractual obligation with the phone carrier and the operating condition of the subsystem of the device.

14. The device-readable medium of claim 13, wherein the upgrade notification user interface of the device includes a software widget presented on a primary screen of the smartphone.

15. The device-readable medium of claim 9, wherein retrieving information related to the upgrade status of the device includes:
identifying a unique identifier of the device; and
obtaining, from a remote service with use of the unique identifier of the device, a status of the contractual obligation with the service provider; and
wherein the status of the contractual obligation with the service provider is used to determine a current upgrade pricing and a future upgrade pricing, the current upgrade pricing based on a trade-in value of the device determined from the characteristics of the device.

16. The device-readable medium of claim 9, wherein retrieving information related to characteristics of the device includes:
identifying a manufacturer, model, and operating system of the device; and
identifying the operating condition of the subsystem of the device, by performing diagnostic tests on the subsystem of the device that indicate the operating condition of the subsystem of the device; and
wherein the promotional offer is customized to the manufacturer, model, operating system of the device, and the operating condition of the subsystem of the device.

17. A computing device comprising:
a processor and a memory; and
an upgrade functionality component implemented by the processor and memory, the upgrade functionality component configured for obtaining information for an upgrade status of the computing device, by performing operations that:
obtain information indicating an upgrade status of the computing device, the upgrade status correlated to a contractual obligation for the computing device;
obtain information indicating operating characteristics of the computing device, the operating characteristics of the computing device including an operating condition of a subsystem of the computing device determined from a diagnostic test; and
obtain information related to a promotional offer for an upgrade of the computing device, the promotional offer based on the operating characteristics of the computing device and the upgrade status of the computing device.

18. The computing device of claim 17, further comprising:
an upgrade functionality widget component operating with use of the processor and memory, the upgrade functionality widget component configured for generating output for display on a primary user interface screen of the computing device, wherein the output for display includes:
a countdown interface, the countdown interface displaying a countdown on the primary user interface screen, the countdown indicating a future time that the upgrade status of the computing device is scheduled to change; and
a promotional display interface, the promotional display interface configured for displaying the promotional offer for the upgrade of the computing device.

19. The computing device of claim 17, further comprising a device settings data store and a software settings data store, wherein the information indicating the upgrade status of the computing device is obtained at least in part with use of information in the device settings data store, and wherein the information indicating the operating characteristics of the computing device is obtained at least in part from the software settings data store.

20. The computing device of claim 17, wherein the upgrade functionality component is included in a downloadable software application, the downloadable software application obtained from an application store providing downloads that are specific to an operating system of the computing device.

21. The computing device of claim 17, further comprising a messaging interface, wherein one or more messages from the upgrade functionality component are output for display by the computing device via the messaging interface.

22. The computing device of claim 17, further comprising a device diagnostics component operating with use of the processor and memory, wherein the device diagnostics component is configured to perform the diagnostic test to determine the operating condition of the subsystem of the computing device.
